(19) United States
(12) Patent Application Publication
(10) Pub. No.: US 2013/0163403 A1
(43) Pub. Date: Jun. 27, 2013

(54) DATA PROCESSING DEVICE OF MULTI-CARRIER SYSTEM AND DATA PROCESSING METHOD THEREOF

(71) Applicants: HyoungOh Bae, Daejeon (KR); Daeho Kim, Daejeon (KR)

(72) Inventors: HyoungOh Bae, Daejeon (KR); Daeho Kim, Daejeon (KR)

(73) Assignee: Electronics and Telecommunications Research Institute, Daejeon (KR)

(21) Appl. No.: 13/619,635

(22) Filed: Sep. 14, 2012

(30) Foreign Application Priority Data
Dec. 23, 2011 (KR) 10-2011-0141161

(51) Int. Cl. H04J 11/00

(52) U.S. Cl. 370/210

(57) ABSTRACT

A data processing method of a multi-carrier receiving device, according to an embodiment of the present invention, includes determining a data processing order for user data provided from a plurality of different users according to a unit data length detected from user information, processing in parallel the user data according to the determined data processing order by using a plurality of inverse discrete Fourier transform (IDFT) engines, and recombining the in-parallel-processed data on a per-user basis with reference to the data processing order and timing information.

### CROSS-REFERENCE TO RELATED APPLICATIONS

This U.S. non-provisional patent application claims priority under 35 U.S.C. §119 of Korean Patent Application No. 10-2011-0141161, filed on Dec. 23, 2011, the entire contents of which are hereby incorporated by reference.

### BACKGROUND OF THE INVENTION

The present invention disclosed herein relates to a communication system, and more particularly, to a receiving device of a multi-carrier system and a data processing method thereof.

In an orthogonal frequency division multiplexing (OFDM) system, a transmitter performs symbol mapping by using an orthogonal characteristic between sub-carriers. The transmitter maps a symbol-mapped signal to each of the sub-carriers. Thereafter, the transmitter performs an inverse fast Fourier transform (IFFT) to the signal mapped to the sub-carrier in order to transmit the signal, and a receiver performs a fast Fourier transform (FFT) in order to receive the signal.

Due to characteristics of the OFDM using a plurality of orthogonal sub-carriers, an IFFT-processed signal has a high peak-to-average power ratio (PARR). In order to reduce the PARR, in the multi-carrier system, a signal distortion technique, an encoding technique, and a scrambling technique are used. However, these techniques may nonlinearly distort a signal, causing performance degradation. Further, these techniques require excessive hardware resources or long processing time to implement a receiving algorithm. For overcoming these limitations, a recent multi-carrier system uses a single carrier-frequency division multiple access (SC-FDMA) method. The SC-FDMA method is used as an uplink standard of an LTE system which is one of 4th generation mobile telecommunication standards. According to the SC-FDMA method, before the IFFT is performed in a modulator, a DFT is performed as much as a data length. According to the SC-FDMA method, a processing time that is longer than a time length of a signal is required for designing hardware due to algorithm characteristics of the DFT. For overcoming this limitation, a plurality of IDFT engines are adopted for designing demodulator hardware. However, since a plurality of signals of users should be processed in a base station, IDFTs with different lengths may have to be performed within a determined period of time.

Therefore, in a system using the SC-FDMA method, it is needed to reduce the processing time by efficiently processing the IDFT in addition to the use of the plurality of IDFT engines.

### SUMMARY OF THE INVENTION

The present invention provides a data processing device for performing a conversion operation to a received signal at a high speed, and a data processing method thereof.

Embodiments of the present invention provide data processing methods of a multi-carrier receiving device, including determining a data processing order for user data provided from a plurality of different users according to unit data lengths detected from user information, processing in parallel the user data according to the determined data processing order by using a plurality of inverse discrete Fourier transform (IDFT) engines, and recombining the in-parallel-processed data on a per-user basis with reference to the data processing order and timing information.

In other embodiments of the present invention, data processing devices include a data storage memory configured to store reception data from a plurality of users, a data selection unit configured to select reception data of the data storage memory with reference to information on a data processing order, a parallel inverse discrete Fourier transform (IDFT) processing unit configured to sequentially receive the data selected by the data selection unit and perform an IDFT operation thereto, a data processing unit configured to rearrange data sequentially outputted from the parallel IDFT processing unit on a per-user basis with reference to the data processing order information and timing information, and a hardware control unit configured to generate the data processing order and the timing information with reference to information on the plurality of users.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a schematic block diagram illustrating a hardware structure of a demodulator according to an embodiment of the present invention;

FIGS. 2A and 2B are timing diagrams exemplarily illustrating a data process of an IDFT processing unit which processes data provided from a single user;

FIGS. 3A and 3B are timing diagrams illustrating that data provided from two users are processed by two IDFT engines;

FIG. 4 is a timing diagram illustrating an output of a parallel IDFT processing unit in the case where user data are provided as illustrated in FIG. 3A or 3B during designing hardware;

FIG. 5 is a schematic timing diagram illustrating a data processing operation according to an embodiment of the present invention; and

FIG. 6 is a schematic flow chart illustrating a data processing method of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the description, when it is described that a certain part includes certain elements, the part may further include other elements. Further, the embodiments exemplified and described herein include complementary embodiments thereof. Hereinafter, an embodiment of the present invention will be described in detail with reference to the accompanying drawings.

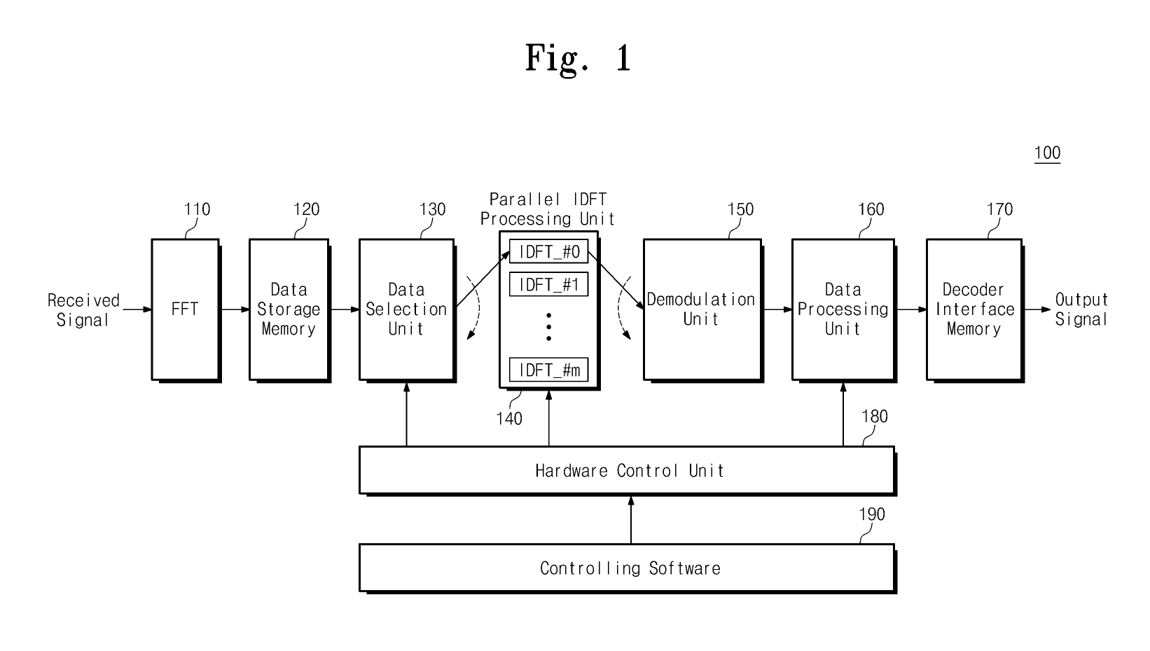

FIG. 1 is a schematic block diagram illustrating a hardware structure of a multi-carrier receiving device according to an embodiment of the present invention. Referring to FIG. 1, a demodulator 100 of the present invention includes an FFT block 110, a data storage memory 120, a data selection unit 130, a parallel IDFT processing unit 140, a demodulation unit 150, a data processing unit 160, a decoder interface memory 170, a hardware control unit 180, and controlling software 190.

The FFT block 110 performs a fast Fourier transform (FFT) to a received signal. The received signal is converted by the FFT block 110 into frequency-domain data.

The data storage memory 120 stores data processed by the FFT block 110. The data storage memory 120 stores the data with reference to user information corresponding to the received signal. For example, the FFT-processed data may be stored in the data storage memory 120 on a user (UE #1) basis. Therefore, addresses are allocated, on a user basis, to the data stored in the data storage memory 120.

The data selection unit 130 receives user information from the hardware control unit 180 to select, from the data storage memory 120, data corresponding to a selected user. The data selection unit 130 transmits data selected by the hardware control unit 180 to the parallel IDFT processing unit 140.

The parallel IDFT processing unit 140 includes a plurality of IDFT engines IDFT#0 to IDFT#m. The parallel IDFT processing unit 140 may reduce a processing time required for the IDFT operation by using the plurality of IDFT engines IDFT#0 to IDFT#m. The parallel IDFT processing unit 140 divides and allocates the data provided from the data selection unit 130 to the plurality of IDFT engines IDFT#0 to IDFT#m so as to process the data according to control of the hardware control unit 180. Each of the plurality of IDFT engines IDFT#0 to IDFT#m performs an M-point inverse discrete Fourier transform (IDFT) operation to received data so as to restore the frequency-domain data converted by the FFT block 110 into time-domain data.

Processing data may be allocated to the IDFT engines IDFT#0 to IDFT#m of the parallel IDFT processing unit 140 according to information on a user and data length. The parallel IDFT processing unit 140 may allow data of users, which have different data length, to be continuously processed by a single IDFT engine. As a result, the parallel IDFT processing unit 140 may adaptively process the IDFT operation, of which processing time is relatively long, according to a user and according to a data length for each user. Data of the same user, which have been processed by different IDFT engines according to a length of the data to reduce the time taken for the IDFT operation, may be rearranged by following elements.

The demodulation unit 150 performs a demodulation operation to the data processed in the parallel IDFT processing unit 140. The demodulation unit 150 processes time-domain data by using various processing techniques according to a modulation technique used during transmission.

The data processing unit 160 generates addresses for the demodulation unit 150 and the decoder interface memory 170 with reference to control information and timing information provided from the hardware control unit 180. The data processing unit 160 stores data provided from the demodulation unit 150 into the decoder interface memory 170 according to the generated addresses.

The hardware control unit 180 provides a control signal including a processing sequence and timing information to the data selection unit 130, the parallel IDFT processing unit 140, and the data processing unit 160. The hardware control unit 180 determines the processing sequence in the parallel IDFT processing unit 140 for user data stored in the data storage memory 120 according to a length of unit data. The hardware control unit 180 provides, in addition to the processing sequence, the timing information to the parallel IDFT processing unit 140 and the data processing unit 160 so as to synchronize processing timing. The hardware control unit 180 may reduce the processing time of the received data through the above-described control operations. The controlling software 190 sets and controls the hardware control unit 180 according to various setting parameters.

The above-described hardware structure of the multi-carrier receiving device may be implemented as an actual receiving device and also may be implemented via HDL coding for designing hardware. The above-described hardware structure may be efficiently used for implementing an algorithm such as DFT, IDFT, FFT, or IFFT, which requires more processing time than input time of a received signal. Further, the above-described hardware structure may be used for reducing algorithm processing time of a modulator and a demodulator for hybrid automatic repeat request (HARQ).

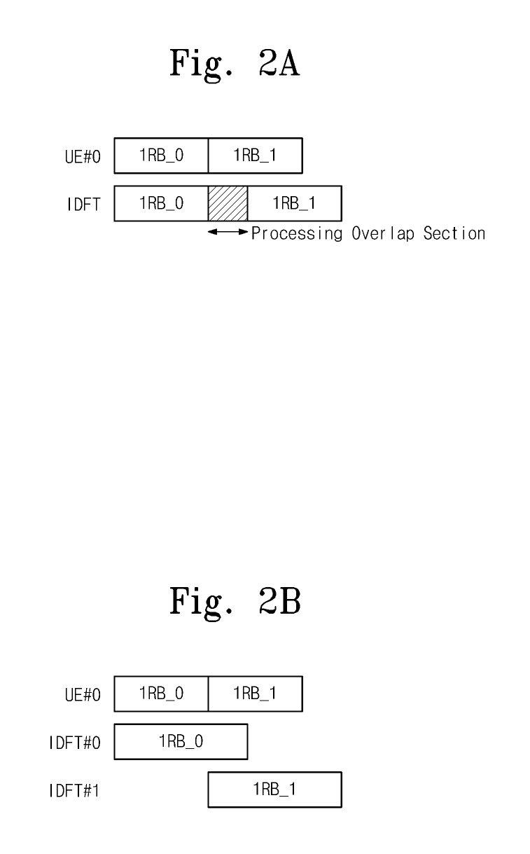

FIGS. 2A and 2B are timing diagrams exemplarily illustrating a data process of the IDFT processing unit which processes data provided from a single user.

FIG. 2A illustrates an example in which two resource blocks (RBs) provided from a single user UE#0 are processed by a single IDFT engine. In general, an operation speed of the IDFT engine is slower than a transmission speed of data. Therefore, before the IDFT engine completes processing of user data 1RB_0, following user data 1RB_1 may be provided to the IDFT engine. Therefore, the IDFT engine may have to simultaneously process two RBs.

FIG. 2A illustrates an example in which two RBs provided from the single user UE#0 are processed by two IDFT engines. In this case, the user data 1RB_0 initially inputted from the user UE#0 are processed by the IDFT#0, and the following user data 1RB_1 are processed by the IDFT#1. Therefore, the user data 1RB_0 and 1RB_1 are processed by different IDFT engines, and an overlap of processing does not occur.

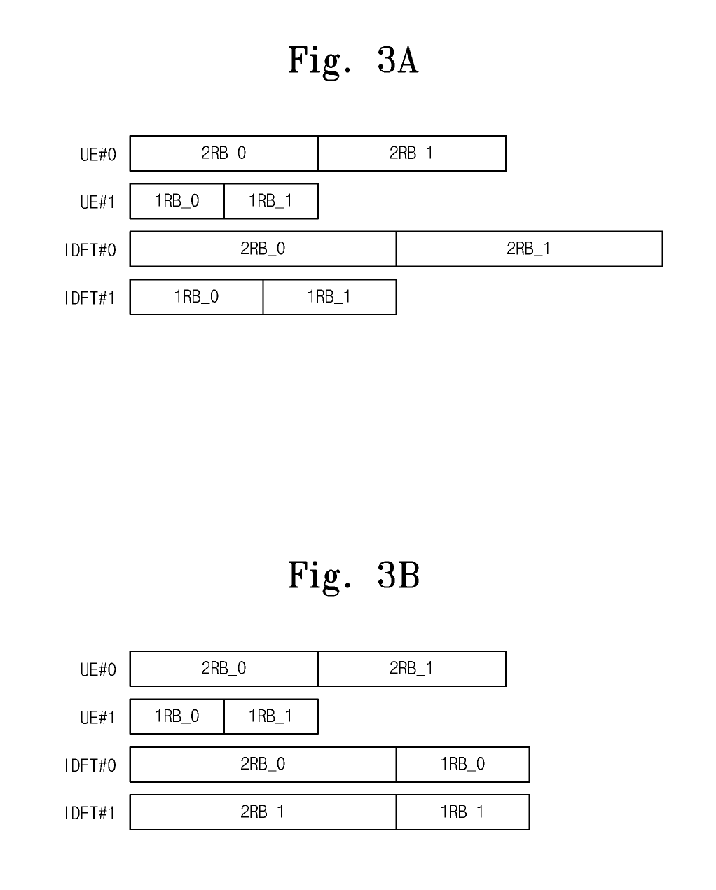

FIGS. 3A and 3B are timing diagrams illustrating that data provided from two users UE#0 and UE#1 are processed by two IDFT engines. FIG. 3A illustrates that the IDFT engines process user data in order of provision of the data. FIG. 3B illustrates a processing technique in the case where the IDFT engines adjusts the order of the user data.

FIG. 3A illustrates the user data respectively provided from the two users UE#0 and UE#1. The user UE#0 provides user data 2RB_0 and 2RB_1 each having a length of 2 RB. The user UE#1 provides user data 1RB_0 and 1RB_1 each having a length of 1 RB.

The IDFT engine IDFT#0 processes only the data having a length of 2 RB provided from the user UE#0. It is assumed that the IDFT engine IDFT#1 processes only the data having a length of 1 RB provided from the user UE#1. The IDFT engines IDFT#0 and IDFT#1 process the data respectively provided from the users in order of provision of the data. That is, the IDFT engines IDFT#0 and IDFT#1 process data on a first-come-first-served basis.

However, even though data are in parallel processed by the two IDFT engines IDFT#0 and IDFT#1, the IDFT engine IDFT#0, which processes relatively longer data, requires a longer processing time. That is, even though data are in parallel processed, in the case where the IDFT engine is fixed to a particular user and data are processed in order of input of the data, a relatively long time is needed for the IDFT operation. Further, although only two users are exemplarily illustrated, a base station actually has to process data provided from more than two users. In this case, the time taken for the IDFT operation is determined by existence of a user who provides relatively longer data.

FIG. 3B is a timing diagram illustrating that the IDFT engine adjusts data regardless of an order of provision of the data so as to perform the parallel-processing IDFT operation. Referring to FIG. 3B, it is assumed that the data respectively provided from the two users UE#0 and UE#1 are the same as those of FIG. 3A. Herein, the hardware control unit 180 (see FIG. 1) rearranges the user data stored in the data storage memory 120 (see FIG. 1) regardless of a provision order of the data so that the processing time of the data is minimized. Then, the hardware control unit 180 respectively transmits the user data to the IDFT engines of the parallel IDFT processing unit 140 with reference to the rearranged order.

For example, the hardware control unit 180 may transmit, to the IDFT engine IDFT#0, the user data 2RB_0 having a length of 2 RB provided from the user UE#0 and the data 1RB_0 having a length of 1 RB provided from the user UE#1. The hardware control unit 180 may transmit, to the IDFT engine IDFT#1, the user data 2RB_1 having a length of 2 RB provided from the user UE#0 and the data 1RB_1 having a length of 1 RB provided from the user UE#1.

However, it should be considered that a plurality of pieces of data cannot be in parallel provided at the same time to the parallel IDFT processing unit 140 from the data storage memory 120. This is because a single channel is provided for an interface between the data selection unit 130 and the data storage memory 120. Therefore, it is needed to consider the data channel to the data storage memory 120 in order to process data.

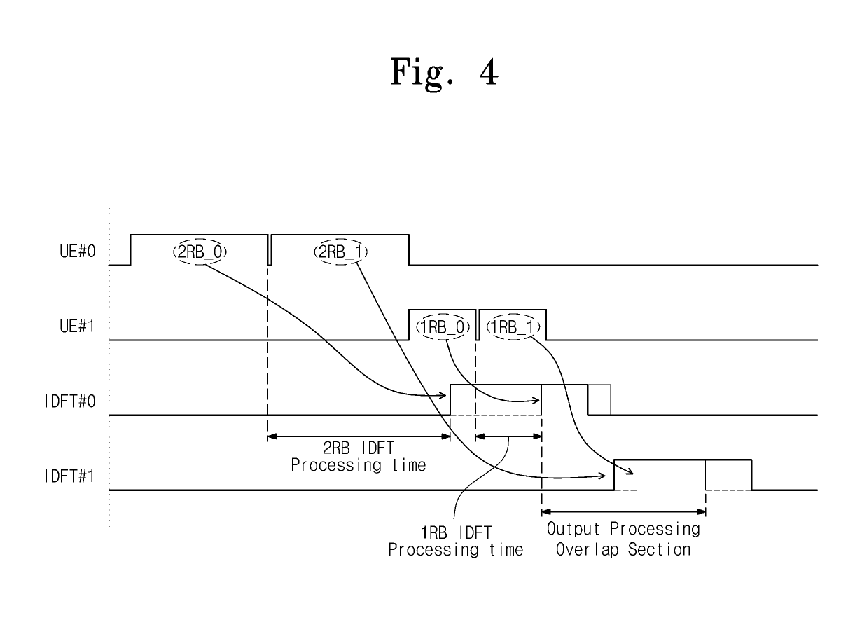

FIG. 4 is a timing diagram illustrating an output of the parallel IDFT processing unit 140 in the case where user data are provided as illustrated in FIG. 3A or 3B during designing hardware. Referring to FIG. 4, in the case of performing the IDFT operation regardless of the order of provision of the user data, data collision may occur at an output terminal of the parallel IDFT processing unit 140.

Herein, it is assumed that the user UE#0 provide data having a length of 2 RB, and the user UE#1 provides data having a length of 1 RB. The user data 2RB_0 and 2RB_1 of the user UE#0 are sequentially read, and are respectively allocated to the IDFT engines IDFT#0 and IDFT#1. The user data 1RB_0 and 1RB_1 of the user UE#1 are sequentially read, and are respectively allocated to the IDFT engines IDFT#0 and IDFT#1. In this case, when the IDFT operations of the IDFT engines IDFT#0 and IDFT#1 are completed and data are outputted therefrom, an output overlap section is generated as shown.

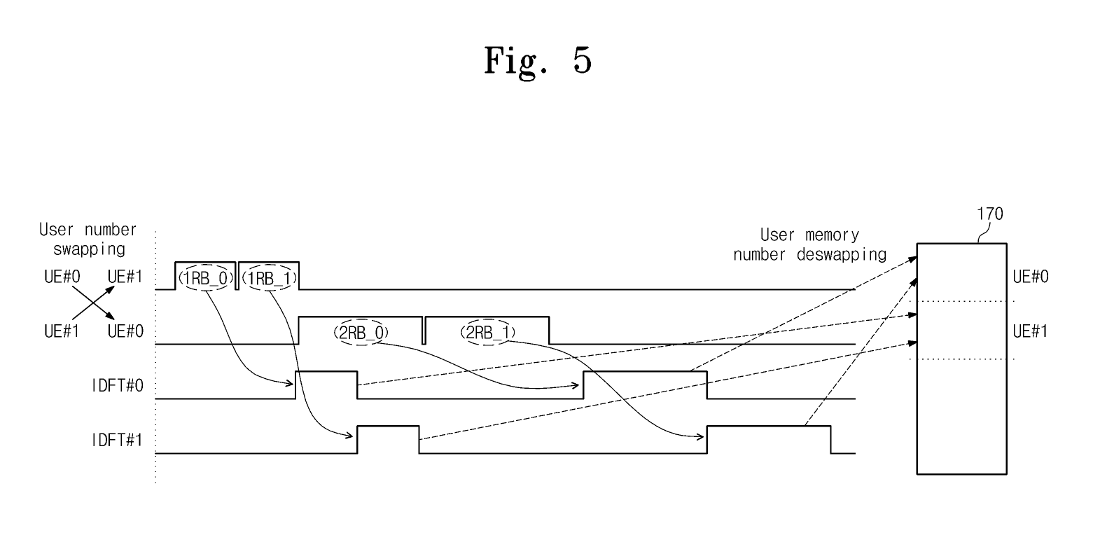

FIG. 5 is a schematic timing diagram illustrating a data processing operation according to an embodiment of the present invention. Referring to FIG. 5, it is assumed that the data storage memory 120 stores data having a data unit of 2 RB of the user UE#0 and data having a data unit of 1 RB of the user UE#1.

The hardware control unit 180 (see FIG. 1) determines an order of the IDFT processes not according to users but according to lengths of data of the users. That is, the hardware control unit 180 changes the process order so as to firstly process user data having a relative short data length. Then, the data selection unit 130 (see FIG. 1) generates addresses according to the process order determined by the hardware control unit 180, and reads the user data from the data storage memory 120 to provide the user data to the parallel IDFT processing unit 140. The data selection unit 130 firstly reads the user data 1RB_0 of the user UE#1 and allocates the read data to the IDFT engine IDFT#1 of the parallel IDFT processing unit 140. The data selection unit 130 reads the user data 1RB_1 and allocates the read data to the IDFT engine IDFT#1 of the parallel IDFT processing unit 140.

Thereafter, the data selection unit 130 reads the user data 2RB_0 of the user UE#0 and allocates the read data to the IDFT engine IDFT#0 of the parallel IDFT processing unit 140. The data selection unit 130 reads the user data 2RB_1 and allocates the read data to the IDFT engine IDFT#1 of the parallel IDFT processing unit 140.

The user data 1RB_0 processed by the IDFT engine IDFT#0 is thereafter stored, by the data processing unit 160 (see FIG. 1), into a memory region of the decoder interface memory 170, which is allocated to the user UE#1. The user data 1RB_1 processed by the IDFT engine IDFT#1 is thereafter stored, by the data processing unit 160, into the memory region of the decoder interface memory 170, which is allocated to the user UE#1.

The user data 2RB_0 processed by the IDFT engine IDFT#0 is thereafter stored, by the data processing unit 160, into a memory region of the decoder interface memory 170, which is allocated to the user UE#0. The user data 2RB_1 processed by the IDFT engine IDFT#1 is thereafter stored, by the data processing unit 160, into the memory region of the decoder interface memory 170, which is allocated to the user UE#0.

In the timing diagram of FIG. 5, an operation of the demodulation unit 150 is omitted. According to the data processing method of the present invention, processed data may be outputted from the parallel IDFT processing unit 140 without an overlap of the data. Therefore, the demodulation unit 150 consisting of a single hardware block sequentially performs demodulation operations and transmit demodulated data to the data processing unit 160.

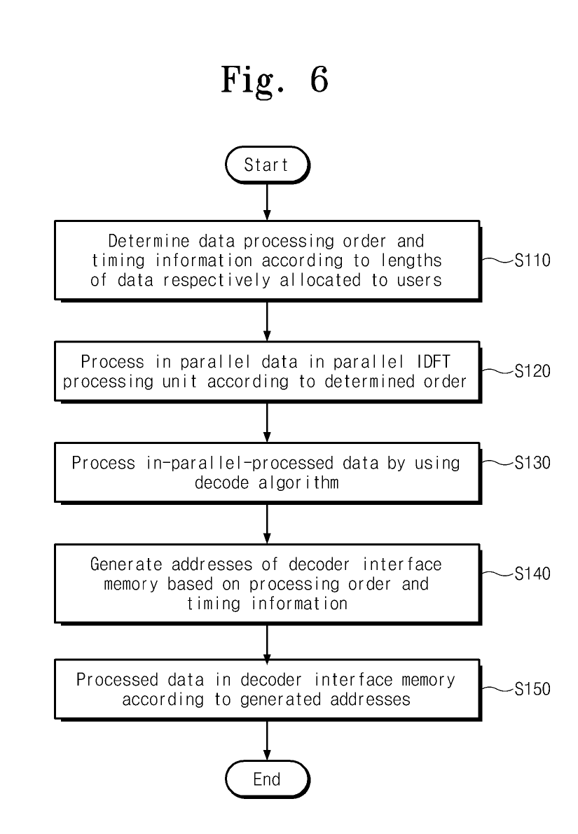

FIG. 6 is a schematic flow chart illustrating a data processing method of the present invention. Referring to FIG. 6, an order of processing user data may be adjusted according to lengths of the data, thereby improving efficiency of the parallel IDFT processing unit 140. This will be described in detail below.

In operation S110, the hardware control unit 180 (see FIG. 1) determines an order of the IDFT processes not according to users but according to lengths of data of the users. That is, the hardware control unit 180 changes, with reference to the user information, the process order so as to firstly process user data having a relative short data length. Then, the data selection unit 130 (see FIG. 1) generates addresses according to the process order determined by the hardware control unit 180, and reads the user data from the data storage memory 120 to provide the user data to the parallel IDFT processing unit 140.

For example, the data selection unit 130 firstly reads the user data 1RB_0 of the user UE#1 and allocates the read data to the IDFT engine IDFT#0 of the parallel IDFT processing unit 140. The data selection unit 130 reads the user data 1RB_1 and allocates the read data to the IDFT engine IDFT#1 of the parallel IDFT processing unit 140. Thereafter, the data selection unit 130 reads the user data 2RB_0 of the user UE#0 and allocates the read data to the IDFT engine IDFT#0 of the parallel IDFT processing unit 140. The data selection unit 130 reads the user data 2RB_1 and allocates the read data to the IDFT engine IDFT#1 of the parallel IDFT processing unit 140.

In operation S120, the parallel IDFT processing unit 140 performs the IDFT operation to user data which are provided according to the determined process order. When the parallel process is performed by the parallel IDFT processing unit 140 according to the above-described process order, processed data do not collide with each other at an output terminal.

In operation S130, the demodulation unit 150 sequentially processes the processed data outputted from the parallel IDFT processing unit 140 according to a decode algorithm. The data processed according to the decode algorithm are provided to the data processing unit 160.

In operation S140, the data processing unit 160 generates addresses of the decoder interface memory 170 with reference to the timing information and the process order determined based on the user information. The process order of the processed data sequentially outputted from the demodulation unit 150 has been changed according to lengths of the data. Therefore, it is needed to restore data for each user on the basis of the process order and the timing information. The data processing unit 160 performs a restoration operation to the processed data outputted from the demodulation unit 150 by setting addresses on the decoder interface memory 170.

In operation S150, the data processing unit 160 stores processed data sequentially provided from the demodulation unit 150 into the decoder interface memory 170 according to the generated addresses.

According to an embodiment of the present invention, the parallel processing order can be changed according to lengths of user data received by the multi-carrier system. By virtue of this operation, the processing time required for performing a Fourier algorithm to the received signal can be reduced. Particularly, hardware can be efficiently designed when an algorithm which requires more time to be processed than input time of the received signal is implemented, or when a system for reducing processing time of the modulator and demodulator for hybrid automatic repeat request (HARQ) is implemented.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A data processing method of a multi-carrier receiving device, the data processing method comprising:
determining a data processing order for user data provided from a plurality of different users according to unit data lengths detected from user information;
processing in parallel the user data according to the determined data processing order by using a plurality of inverse discrete Fourier transform (IDFT) engines; and
recombining the in-parallel-processed data on a per-user basis with reference to the data processing order and timing information.

2. The data processing method of claim 1, wherein the data processing order is such configured that reception data of a first user, having a short unit data length, are allocated to the plurality of IDFT engines to be in parallel processed, and then, reception data of a second user, having a unit data length longer than that of the first user, are allocated to the plurality of IDFT engines to be in parallel processed.

3. The data processing method of claim 1, wherein the user data respectively corresponding to the plurality of users are divided to be allocated to and in parallel proceed by the plurality of IDFT engines.

4. The data processing method of claim 1, further comprising sequentially demodulating the in-parallel-processed user data according to a modulation algorithm.

5. The data processing method of claim 1, wherein the recombining of the in-parallel-processed data is performed by generating addresses of a decoder interface memory, which respectively correspond to the plurality of users.

6. The data processing method of claim 1, wherein the multi-carrier receiving device is configured via HDL coding for designing hardware.

7. A data processing device comprising:
a data storage memory configured to store reception data from a plurality of users;
a data selection unit configured to select reception data of the data storage memory with reference to information on a data processing order;
a parallel inverse discrete Fourier transform (IDFT) processing unit configured to sequentially receive the data selected by the data selection unit and perform an IDFT operation thereto;
a data processing unit configured to rearrange data sequentially outputted from the parallel IDFT processing unit on a per-user basis with reference to the data processing order information and timing information; and
a hardware control unit configured to generate the data processing order and the timing information with reference to information on the plurality of users.

8. The data processing device of claim 7, further comprising a decoder interface memory configured to store processed data outputted from the parallel IDFT processing unit on a per-user basis.

9. The data processing device of claim 8, wherein the data processing unit generates addresses of the decoder interface memory with reference to the data processing order information and the timing information.

10. The data processing device of claim 7, wherein the hardware control unit generates the data processing order information with reference to data length information in a plurality of pieces of user data.

11. The data processing device of claim 10, wherein the hardware control unit generates the data processing order information so that user data having a shortest data length are in parallel processed by the parallel IDFT processing unit.

12. The data processing device of claim 7, further comprising a demodulation unit configured to sequentially receive processed data of the parallel IDFT processing unit, process the received data according to a modulation algorithm, and provide the modulated data to the data processing unit.

13. The data processing device of claim 7, wherein the data storage memory, the data selection unit, the parallel IDFT processing unit, the data processing unit, and the hardware control unit is configured via HDL coding for designing hardware.
